(19) United States
(12) Patent Application Publication
(10) Pub. No.: US 2011/0219538 A1
(43) Pub. Date: Sep. 15, 2011

(54) Support Means for a Patient Handling Hoist

(76) Inventors: Nathan McWattie, Gloucestershire (GB); Nigel Heales, Shropshire (GB); Paul Brookes, Worcestershire (GB)

(21) Appl. No.: 13/054,209

(22) PCT Filed: Jun. 26, 2009
(86) PCT No.: PCT/GB2009/001620

§ 371 Date: May 19, 2011

(30) Foreign Application Priority Data
Jul. 14, 2008 (GB) 0812762.3

(51) Int. Cl. A61G 7/10

(52) U.S. Cl. 5/87.1

(57) ABSTRACT

A support device for a patient handling hoist includes two opposed support arms for supporting a harness, each support arm having a harness engagement element. Each support arm is movable between a first working position in which the harness engagement element is a first distance from a central portion of the support device and a plurality of further working positions in which the harness engagement elements of the support arms are a respective plurality of distances from the central portion of the support device.

### RELATED APPLICATIONS

This application claims priority from PCT patent application PCT/GB2009/001620, entitled SUPPORT MEANS FOR A PATIENT HANDLING HOIST, filed Jun. 26, 2009, currently pending; PCT/GB2009/001620 claims priority from British application GB0812762.3, entitled SUPPORT MEANS FOR A PATIENT HANDLING HOIST, filed Jul. 14, 2008.

### TECHNICAL FIELD

The present invention relates to a patient hoist and particularly but not exclusively to a patient hoist support from which a patient sling or harness can be supported.

### BACKGROUND OF THE INVENTION

It is known to provide a patient hoist, also known as a winch assembly or overhead motor, for lifting patients, for example in hospitals and care homes. Typically the patient hoist is attached to an overhead support, such as a ceiling mounted rail or a rail mounted on temporarily or permanently positioned floor to ceiling support posts. A support means is typically either attached to or integrated into the patient hoist and usually comprises a fixed horizontal support bar or arm disposed beneath the patient hoist, from which the straps of a sling or harness can be supported for supporting a patient. Upwardly extending hooks or retainers are usually provided at the distal ends of the bar, which prevent straps of the sling or harness from sliding off the ends of the bar.

There is a need to provide a patient hoist with a support or support bars having improved functioning.

### SUMMARY OF THE INVENTION

According to this invention there is provided a support device for a patient handling hoist, comprising two opposed support arms for supporting a harness, each support arm having a harness engagement element. Each support arm is movable between a first working position in which the harness engagement element is a first distance from a central portion of the support device and a plurality of further working positions in which the harness engagement elements of the support arms are a respective plurality of distances from the central portion of the support device.

According to this invention there is also provided a support device for a patient handling hoist, comprising two opposed support arms for supporting a harness. Each support arm has a harness engagement element, and each support arm is movable between a first working position in which the harness engagement element is a first distance from a central portion of the support device and a plurality of further working positions in which the harness engagement elements of the support arms are a respective plurality of distances from the central portion of the support device. The support arms are mounted in a manner in which movement of one support arm in a direction towards or away from the central axis of the support device is replicated in the opposite direction by the opposing support arm.

Various advantages of this invention will become apparent to those skilled in the art from the following detailed description of the preferred embodiment, when read in light of the accompanying drawings.

### BRIEF DESCRIPTION OF THE DRAWINGS

FIG. 1 shows a schematic front view of a hoist supporting a harness and patient;

FIG. 2 shows a schematic exploded perspective view of a first embodiment of a support arm including first and second parts;

FIG. 3A shows a schematic side view of the assembled support arm of FIG. 2 in a first position;

FIG. 3B shows a schematic side view of the assembled support arm of FIG. 2 in a second position;

FIG. 3C shows a schematic side view of the assembled support arm of FIG. 2 in a third position;

FIG. 4A shows a schematic side view of a second embodiment of a harness engagement provided at the distal end of a support arm;

FIG. 4B shows a schematic side view of a third embodiment of a harness engagement provided at the distal end of a support arm;

FIG. 5 shows a schematic cross-sectional view through a portion of the support arm of FIG. 2;

FIG. 6A shows a schematic perspective view of a second embodiment of support arm in an extended position;

FIG. 6B shows a schematic cross-sectional view through the support arm of FIG. 6A;

FIG. 7A shows a schematic side view of the support arm of FIGS. 6A and 6B in a first position;

FIG. 7B shows a schematic side view of the support arm of FIGS. 6A to 7A in a second position;

FIG. 7C shows a schematic side view of the support arm of FIGS. 6A to 7B in a third position;

FIG. 8 shows an exploded schematic perspective view of the support arm of FIGS. 6A to 7C;

FIG. 9A shows a schematic cross-sectional view of a support incorporating a third embodiment of support arm;

FIG. 9B shows a schematic exploded view of the support of FIG. 9A; and

FIG. 10 shows a schematic perspective view of a fourth embodiment of a support;

FIG. 11 shows a schematic perspective view of the support of FIG. 10, with part of the casing cut away to show the internal components;

FIG. 12 shows a schematic perspective view of a support arm of the support shown in FIGS. 10 and 11, together with part of the casing of the support; and

FIG. 13 shows a schematic cross-section through a central portion of the support of FIGS. 10 and 11.

### DETAILED DESCRIPTION OF THE INVENTION

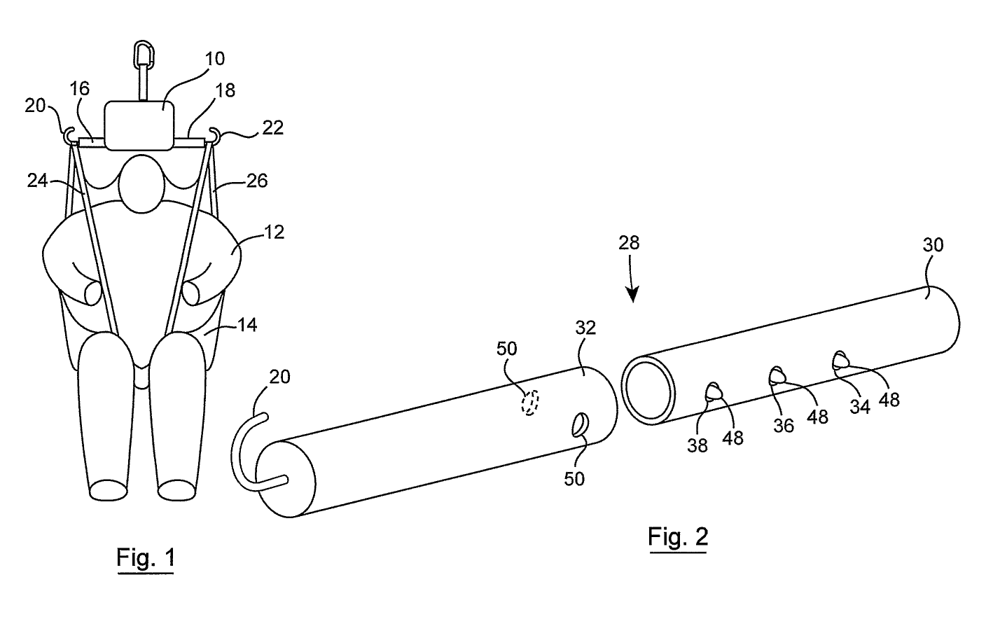

Referring firstly to FIG. 1, a patient hoist 10 is shown supporting a patient 12 in a harness 14. A harness support includes opposed first and second support arms 16, 18 extending from respective sides of the patient hoist 10. Hooks 20, 22 disposed at respective distal ends of the first and second support arms 16, 18 provide a harness engagement, which support straps 24, 26 of the harness 14.

Referring now to FIG. 2, a first embodiment of telescopic support arm is indicated generally at 28. The support arm 28 comprises first and second tubular parts 30, 32, the first part 30 sliding within the second part 32. The first inner part 30 is attached to the patient hoist 10 and the second outer part 32 locates and slides over the first part 30. The outer part 32 can be located and locked in three positions relative to the inner part 30. Optionally, the outer part 32 can be located and locked in more or less than three positions relative to the inner part 30. The tubular parts 30, 32, can have a circular cross-section, or any other suitable cross-section. It can be seen that each support arm is movable between a first working position in which a distal end of the support arm is a first distance from the center of the support device and a plurality of further working positions in which the ends of the support arms are a respective plurality of distances from the center of the support device

Referring also to FIG. 5, three through apertures 34, 36, 38 are longitudinally spaced along the first part 30. The apertures 34, 36, 38 are aligned in a plane through the central axis of the first part 30, indicated at 40. Respective spring clips 42, 44, 46 are disposed within the first part 30 and have a central U-shaped body. Detents 48 are provided at the two distal ends of each spring clip 42, 44, 46, which extend through the apertures 34, 36, 38 and protrude beyond the outer wall of the first part. A further through aperture 50 is provided through the second part 32 on a similar plane, such that it is capable of being aligned with any one of the apertures 34, 36, 38.

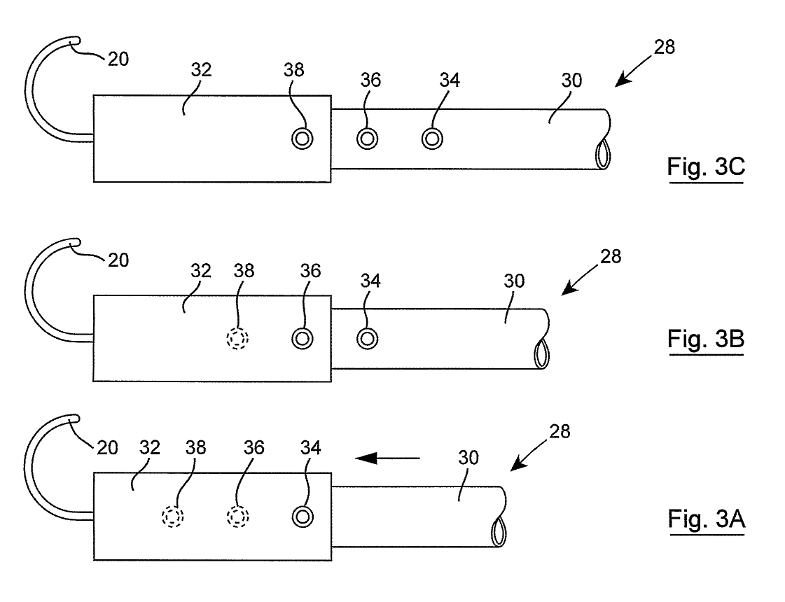

In use, the detents 48 can be depressed by hand into the apertures 34, 36, 38, thereby allowing the second part 32 to slide freely over the first part 30. When the aperture 50 of the second part 32 is aligned with any one of the apertures 34, 36, 38 of the first part 30, the detents 48 of the respective spring clip 42, 44, 46 automatically engage in the aperture 50 and lock the first and second parts relative to one-another. With reference also to FIGS. 3A, 3B and 3C, the support bar 28 is shown in a series of positions from a retracted position, as shown in FIG. 3A to an extended position as shown in FIG. 3C.

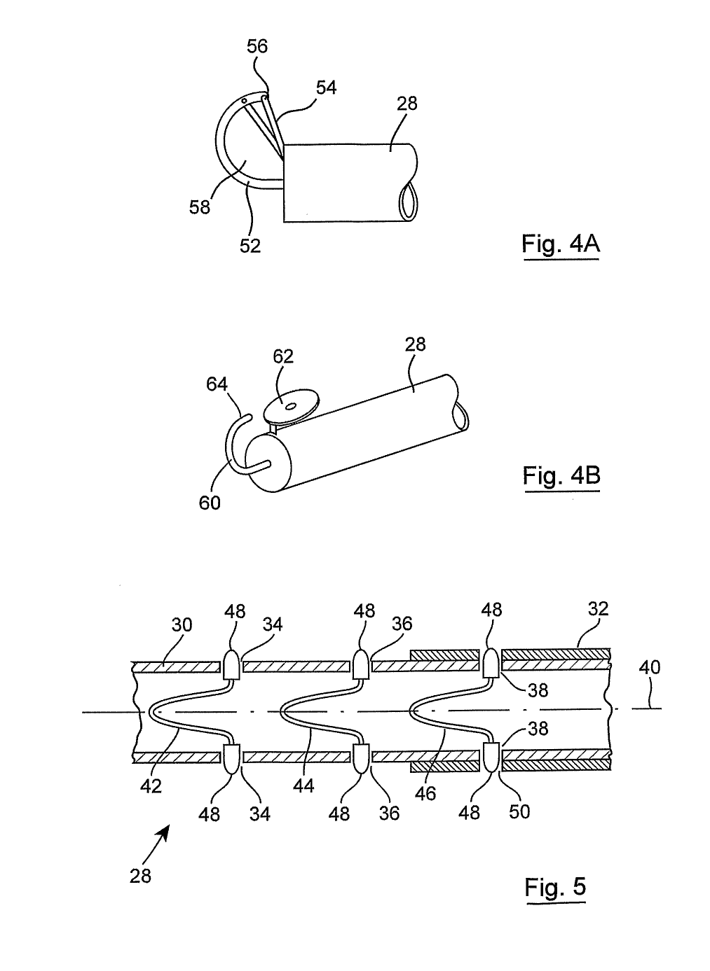

Referring now to FIG. 4A, a first embodiment of a harness engagement is shown provided at the distal end of a support arm 28. The harness engagement includes an upwardly curving hook member 52 extending from a central region of the end of the support arm 28. A closure member comprising a spring clip 54 is pivotally mounted to an upper distal tip 56 of the hook member 52 and is biased upwardly into contact with an upper region of the end of the support arm 28 to form an enclosed loop 58. A strap of a harness is thereby prevented from becoming unintentionally detached from the harness engagement, when the harness is being loaded and unloaded. The spring clip 54 can be depressed into the hook member 52 to allow a harness strap to be inserted and removed, when desired.

A second embodiment of a harness engagement is shown in FIG. 4B. The harness engagement includes an upwardly curving hook member 60, similar to hook member 52 in the first embodiment. A closure member 62 is mounted to the upper surface of the support arm 28 and is biased away from the support arm into contact with an upper distal tip 64 of the hook member 60, thereby preventing unintentional detachment of a harness strap from the hook member 60. The closure member 62 can be depressed away from the tip 64 to allow a harness strap to be inserted and removed, when desired. Further upwardly curving hook members (not shown) can also be attached to the end of the support arm 28, for example, extending in other directions, which may be orthogonal to the direction of the hook member 60.

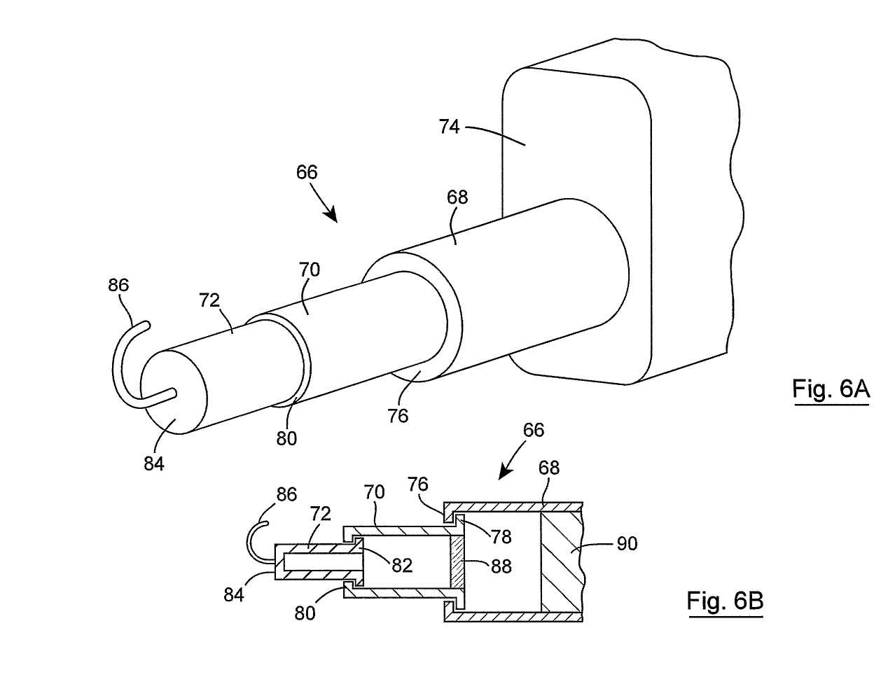

Referring to FIGS. 6A and 6B, a second embodiment of a support arm is indicated generally at 66. The support arm 66 includes first, second and third tubular parts 68, 70, 72, which slide one within the other telescopically. One end of the first part 68 is attached to a patient handling hoist 74 and the other end terminates in an inwardly extending peripheral flange 76. Referring in particular to FIG. 6B, the second part 70 slides within the first part 68, and has an external peripheral flange 78 disposed at its inner end and an inwardly extending peripheral flange 80 disposed at its outer end. Similarly, the third part 72 has an external peripheral flange 82 disposed at its inner end. The outer end of the third part is capped at 84 and a harness engagement, for example, an upwardly extending hook member 86, is attached to the capped portion 84. Plugs 88, 90 are fitted inside the inside ends of the second and first parts respectively during assembly of the support arm 66, which act as physical stops to prevent the third and second parts 72, 70 from being pushed too far into the second and first parts 70, 68.

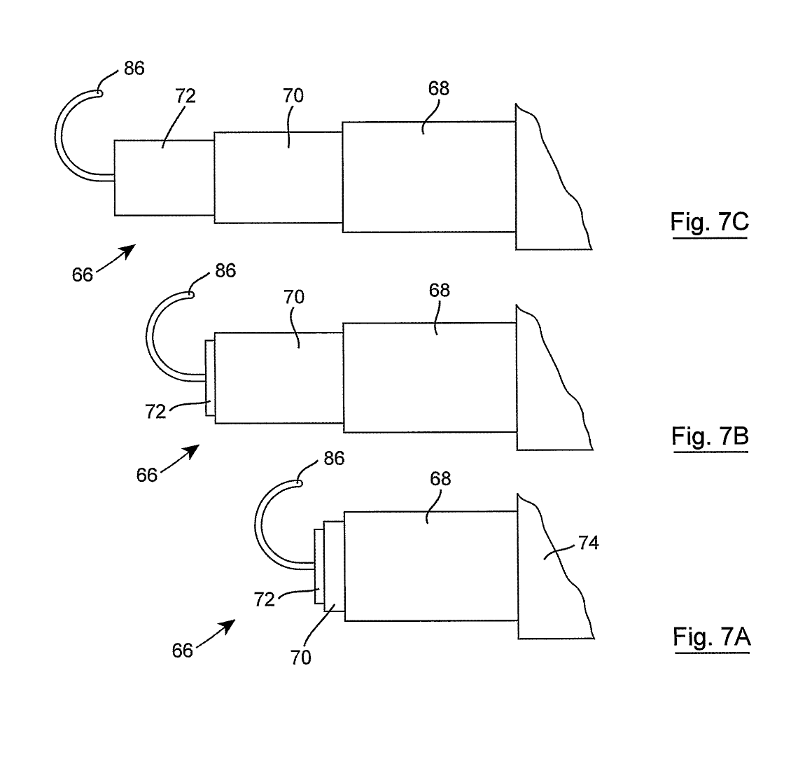

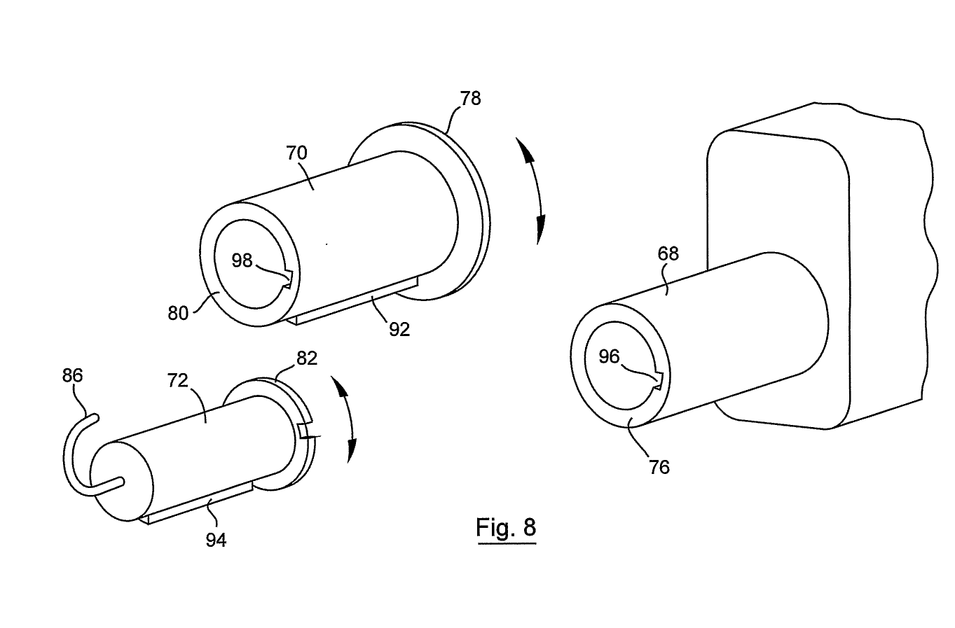

The support arm 66 can be seen in three different support positions for lifting in FIGS. 7A to 7C. In FIG. 7A the support arm is fully retracted in the desired position for transport. In this position, the third and second parts 72, 70 are both substantially enclosed by the first part 68. The inner end of the third part 72 is abutted against the stop provided by the plug 88 and the inner end of the second part is abutted against the stop provided by the plug 90. In FIG. 7B, the support arm 66 is partially extended. In this position, the second part has been moved out of the first part 68 until the flange 78 abuts against the flange 76. In FIG. 7C, the support arm is fully extended. In this position, the first and second parts are in the same position as in FIG. 7B, and the third part has been moved out of the second part 70 until the flange 82 abuts the flange 80.

Referring now to FIG. 8, the lock for the support arm 66 (not previously shown) will now be described. Elongate axial lugs or projections 92, 94 are provided on the underside of the second and third parts 70, 72. The lugs 92, 94 do not extend up to the external flanges 78, 82, but are short by a distance substantially equal to the thickness of the flanges 76, 80 respectively. Cut-aways 96, 98 are provided in the flanges 76, 80 respectively, which are sufficient to allow the lugs 92, 94 to pass through the flanges. However, the cut-aways 96, 98 are not axially aligned with the natural rest position of the lugs, i.e. facing downwardly, but are angularly off-set through an angle of approximately 90°.

In use, when the support arm 66 is retracted, as shown in FIG. 7A, the lugs 92, 94 lie against the inside walls of the first and second parts 68, 70. In order to extend the support arm to the position shown in FIG. 7B, the second part 70 is rotated through 90° relative to the first part so that the lug 92 is aligned with the cut-away 96. The second part 70 can then be extended out of the first part. The second part 70 is then rotated back the other way and the flange 76 is axially locked between the flange 78 and the lug 92, thus preventing axial movement of the second part 70 relative to the first part.

Similarly, the third part 72 is extended by rotation of the third part to align the lug 94 with the cut-away 98 in the flange 80 of the second part 70, thus allowing axial movement of the third part 72 relative to the second part 70. When extended, the lug is rotated away from the cut-away 98 and the flange 76 is then axially locked between the flange 78 and the lug 92, thus preventing axial movement of the second part 70 relative to the first part. Retraction of the second and third parts 70,72 is achieved by similar alignment of the lugs with the cutaways.

In another locking arrangement (not shown), the lugs and cut-aways can be replaced with a projection provided on each of the internal flanges, each projection engaging in a slot or recess formed on the outer wall of an adjacent inner part.

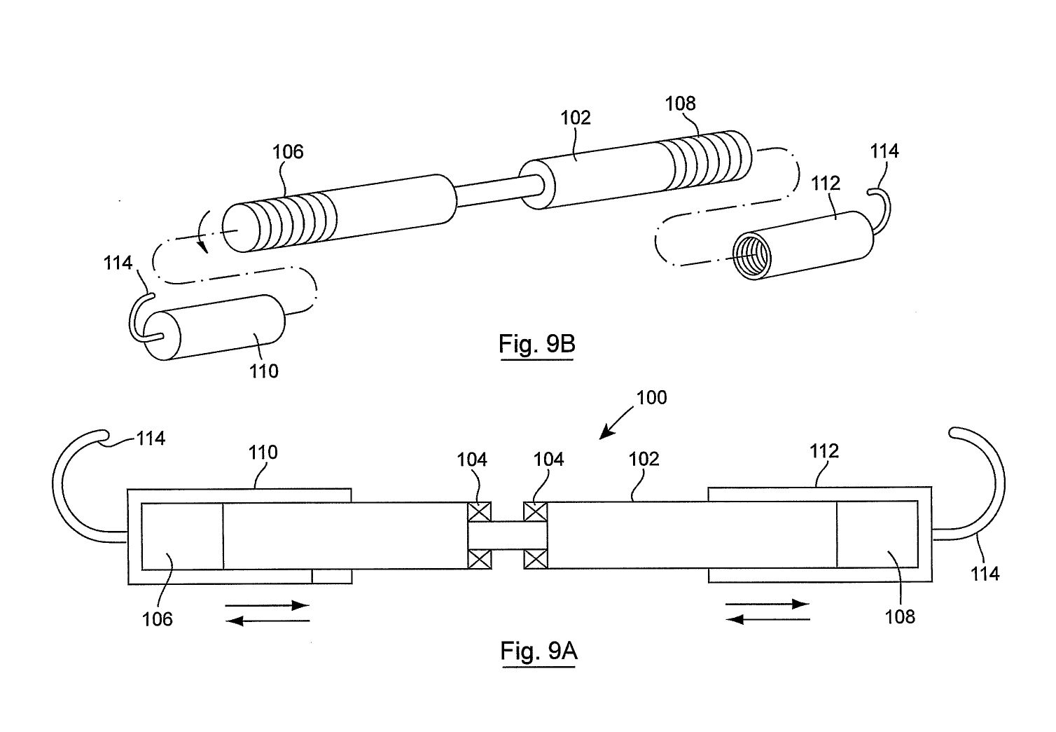

Referring now to FIG. 9A, a third embodiment of a support member is indicated at 100. A support shaft 102 is mounted for rotation in bearings 104 mounted to the patent handling hoist (not shown). The left hand end 106 of the shaft 102 (as viewed) has an external right-handed thread and the left hand end 108 of the shaft (as viewed) has an external left-handed thread. Left and right internally threaded tubular support arms 110, 112 are mounted on and threadingly engaged with respective ends of the shaft 102. Upwardly curving hook members 114 at the outer distal ends of the support arms 110, 112 provide engagement for the harness.

In use, rotation of the shaft 102 relative to the support arms 110, 112 in a first direction causes the support arms to move simultaneously outwardly of the shaft and rotation in the other direction causes the support arms to move in the other direction, i.e. inwardly towards the center of the shaft. The shaft may be driven, for example by hand or by an electric motor, and lock may be provided to lock the shaft and support arms in a fixed position for use or transport or storage. The support arms can be used in a plurality of positions, depending on the amount of rotation of the shaft 102.

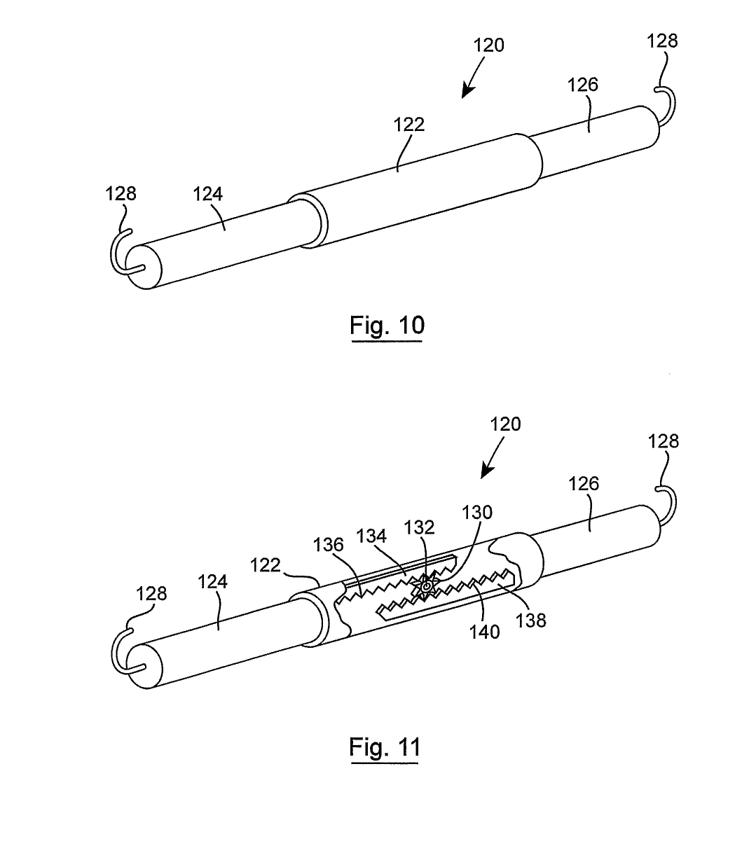

Referring to FIGS. 10 to 13, a fourth embodiment of a support arm is indicated at 120. The support arm 120 has a central housing 122 and a pair of support arms 124, 126, which extend from either side of the central housing 122. A hook 128 is provided at the distal end of each support arm 124, 126 for receiving the straps of a harness or sling.

The support arms 124, 126 are arranged to be moved inwardly and outwardly of the housing 122 simultaneously. A central gear or pinion 130 is pivotally mounted within the housing 122 about a shaft or pivot 132. Each support arm 124, 126 has a substantially circular cross-section, which is received in a respective circular opening provided at each end of the housing 122. A gear track or rack 134 is attached to and extends from the inner facing end of the support arm 124, on the left hand side of the support, as viewed. The rack 134 extends from the upper edge of the periphery of the end of the support arm 124, and teeth 136 of the rack are disposed facing downwardly into engagement with teeth of the pinion 130. A further gear track or rack 138 is attached to and extends from the inner facing end of the support arm 126, on the right hand side of the support, as viewed. The rack 138 extends from the lower edge of the periphery of the end of the support arm 126, and teeth 140 of the rack are disposed facing upwardly into engagement with teeth of the pinion 130.

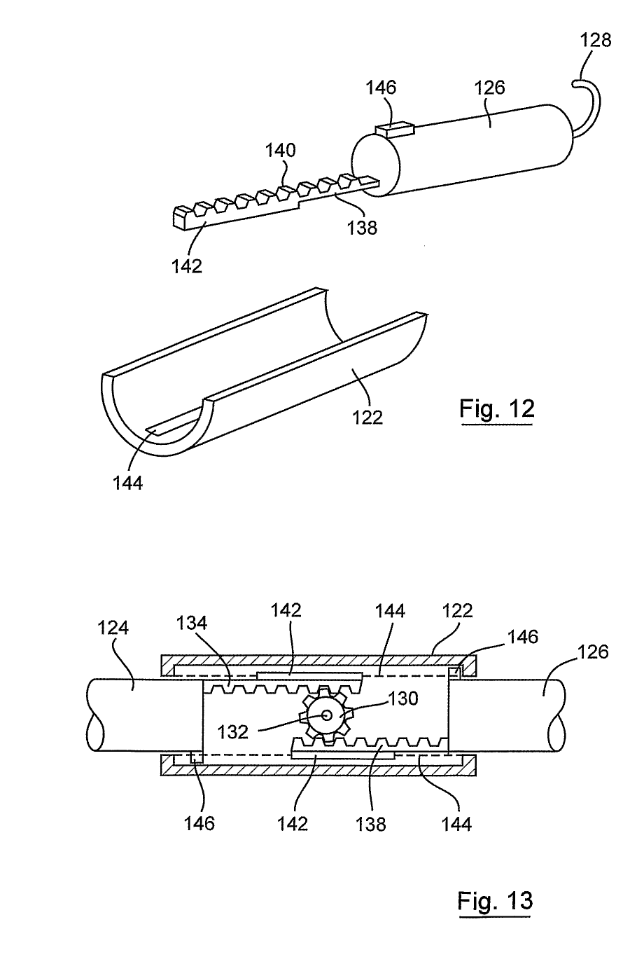

Referring in particular to FIGS. 12 and 13, each rack 134, 138 includes a cam portion 142 extending from the back of the rack, which engages in a cam slot 144 in the wall of a portion of the housing 122 (shown in FIG. 12). The housing may be made in one or more parts for ease of manufacture and assembly. A stop or abutment 146 is disposed at the outer periphery of each support arm 124,126 at the inner end thereof, diametrically opposite the position of the respective rack 134, 138. In use, the stop 146 of the support arm 126 slides within the cam slot 144 in the upper side of the housing, which also receives the cam portion 142 of the support arm 124, i.e. the other support arm. The stop 146 of the support arm 124 slides within the cam slot 144 in the lower side of the housing, which also receives the cam portion 142 of the support arm 126, i.e. the other support arm. The stops 146 prevent the support arms 124, 126 from extending too far out of the housing 122. It is important that a sufficient portion of each support arm 124, 126 is located within the housing 122 in order to transfer the weight of a patient from the support arms to the housing.

In this embodiment, the support arms 124, 126 move simultaneously outward and inward of the housing 122 depending on the direction of rotation of the pinion 130. The housing 122 is either integral with or attached to a patient handling hoist. The pinion 130 may be driven by hand or by an electric motor, and a lock may be provided to lock the pinion and support arms in a fixed position for use or transport or storage. The lock may lock one of the support arms 124,126 to the housing 122 or may lock the pinion 130 against rotation. In the manual arrangement, as one of the support arms is pulled out of the housing 122, this causes rotation of the pinion, which in turn causes the other support arm to be driven out of the other end of the housing.

In the motor driven arrangement, the motor drives the pinion 130 causing the racks and support arms 124, 126 to move. The motor can optionally be controlled by an electronic controller. The controller can be pre-set or pre-programmed to extend the support arms 124,126 to any one of a number of positions, that is, different distances out of the housing 122. The size of a particular patient can be pre-set or recorded by the controller, so that the support arms 124, 126 can be moved to a desired position quickly, once pre-set. A keypad or touch screen can be used to input information to the controller. When using the same hoist for a number of patients of different sizes, this can save a significant amount of time.

In order to make the lifting experience more comfortable for a patient, it is sometimes desirable, depending on the type of harness engagement utilized, to angle the support bars downwardly from the patient handling hoist, for example by 15°. This may be achieved in each of the embodiments, save for the third embodiment, which requires the shaft to be continuous.

Slings for different sizes of patient may be color coded with associated positions of the support arms. Alternatively, other marking indicia may be used to indicate which sling is suitable for use with a particular distance setting of the support arms.

In some embodiments, the patient hoist provides the advantage that the support arm is less bulky, thereby making storage and transportation easier. In some embodiments, the patient hoist provides the advantage of readily accommodating patients of different sizes, and slings of different sizes.

In some of the embodiments, the support arms can be positioned and locked in a variety of different positions to suit a particular patient size. Typically, harnesses can be provided in three different sizes, small, medium and large, and the support arms can be arranged such that the harness engagement is positioned the ideal distance apart for each size of harness. This means that patients can be lifted safely and in comfort. Further, the support arms may be moved and locked in at least three discrete positions, for example providing the harness engagement spaced 440 mm, 540 mm and 640 mm apart, respectively.

It is understood that variations may be made in the foregoing without departing from the scope of the invention. For example, the elements and teachings of the various illustrative embodiments may be combined in whole or in part in some or all of the illustrative embodiments. In addition, one or more of the elements and teachings of the various illustrative embodiments may be omitted, at least in part, and/or combined, at least in part, with one or more of the other elements and teachings of the various illustrative embodiments within the scope of the claims.

The principle and mode of operation of this invention have been described in its preferred embodiments. However, it should be noted that this invention may be practiced otherwise than as specifically illustrated and described without departing from its scope.

1-22. (canceled)

23. A support device for a patient handling hoist, comprising two opposed support arms for supporting a harness, each support arm having a harness engagement element, each support arm being movable between a first working position in which the harness engagement element is a first distance from a central portion of the support device and a plurality of further working positions in which the harness engagement elements of the support arms are a respective plurality of distances from the central portion of the support device.

24. A support device as claimed in claim 23 in which the harness engagement elements are positioned at or proximate a distal end of the support arms, each support arm being movable between a first working position in which a distal end of the support arm is a first distance from a central axis of the support device and a plurality of further working positions in which the ends of the support arms are a respective plurality of distances from the central axis of the support device.

25. A support device as claimed in claim 23 in which each support arm is lockable in each of the working positions.

26. A support device as claimed in claim 23 in which each opposed support arm includes at least a first part and a second part which move relative to one-another.

27. A support device as claimed in claim 26, in which the two opposed support arms are telescopic.

28. A support device as claimed in claim 26, in which a plurality of longitudinally spaced holes are provided through the first part, a single hole is provided through the second part and a lock locates in the single hole of the second part and in any one of the plurality of holes in the first part.

29. A support device as claimed in claim 28, in which the lock includes a plurality of spring clips disposed within a hollow core of the first part, each spring clip being associated with one of the holes and having two detents which protrude through respective apertures of the associated hole on either side of the first part.

30. A support device as claimed in claim 29, in which the detents of each spring clip can be pushed inwardly of the first part sufficient to release the detents from the through hole of the first part and allow the second part to slide relative to the first part for re-positioning.

31. A support device as claimed in claim 26, in which each opposed support arm includes a third part which moves relative to the first and second parts.

32. A support device as claimed in claim 31, in which the harness engagement element is disposed at or proximate a distal end of the third part.

33. A support device as claimed in claim 31, in which the first part is rigidly fastenable to the patient handling hoist, the second part slides within the first part and the third part slides within the second part.

34. A support device as claimed in claim 26, in which internal flanges provided on outer distal ends of the first and second parts co-operate with external flanges provided on inner distal ends of the respective second and third parts to act as stops.

35. A support device as claimed in claim 31, in which an external lug is provided on each of the second and third parts, which act against the respective internal flanges of the first and second parts to prevent the support arm from being telescopically extended and retracted.

36. A support device as claimed in claim 35, in which a cut-away is provided in each of the internal flanges of the first and second parts, through which the respective external lugs of the second and third parts can pass thereby allowing telescopic extension and retraction of the support arm.

37. A support device as claimed in claim 23, in which the harness engagement element of each support arm comprises an upwardly curving hook member and a spring clip disposed at or proximate an upper distal tip of the hook member, the spring clip being biased upwardly into contact with an end region of the support arm to form an enclosed loop.

38. A support device as claimed in claim 23, in which the harness engagement element of each support arm comprises at least one upwardly curving hook member, and a closure member biased away from the support arm into contact with an upper distal tip of the hook member.

39. A support device as claimed in claim 38, in which the harness engagement element of each support arm comprises three upwardly curving hook members disposed in different orthogonal directions, the closure member being biased into contact with the upper distal tips of all of the three hook members.

40. A support device for a patient handling hoist, comprising two opposed support arms for supporting a harness, each support arm having a harness engagement element, each support arm being movable between a first working position in which the harness engagement element is a first distance from a central portion of the support device and a plurality of further working positions in which the harness engagement elements of the support arms are a respective plurality of distances from the central portion of the support device, the support arms being mounted in a manner in which movement of one support arm in a direction towards or away from the central axis of the support device is replicated in the opposite direction by the opposing support arm.

41. A support device as claimed in claim 40, in which each support arm comprises a threaded tubular member connected to a threaded rotatable shaft, wherein rotation of the shaft causes simultaneous movement of both support arms either away from or towards a central portion of the support device.

42. A support device as claimed in claim 40, in which each support arm includes a geared rack in engagement with a respective side of a pinion, whereby rotation of the pinion causes simultaneous movement of both support arms either away from or towards a central axis of the support device.
